(19) United States
(12) Patent Application Publication
(10) Pub. No.: US 2008/0076559 A1
(43) Pub. Date: Mar. 27, 2008

(54) Detachable controller for handheld electronic device

(76) Inventors: Darren Richardson, San Diego, CA (US); Ktson Yu, Hong Kong (CN); Robert Lindsley, San Diego, CA (US); Jon Middleton, San Diego, CA (US)

Correspondence Address: CHARMASSON, BUCHACA & LEACH, LLP, 1545 HOTEL CIRCLE SOUTH, SUITE 150, SAN DIEGO, CA, 92108-3426, US

(21) Appl. No.: 11/741,706

(22) Filed: Apr. 27, 2007

Related U.S. Application Data
(60) Provisional application No. 60/795,316, filed on Apr. 27, 2006.

(51) Int. Cl. G06F 17/00

(52) U.S. Cl. 463/36; 463/47

(57) ABSTRACT

A detachable user input controller having the ability to input control signals into a hand-held electronic device. The controller can be configured to operate similarly to a gun having a trigger and gun-type handle. A mounting connector is formed on the top surface of the gun controller to mount the hand-held electronic device such as a portable electronic game such as a PSP brand or PLAYSTATION PORTABLE brand hand-held electronic game. A releasable collar is provided to secure the game to the controller. The controller includes a three-dimensional motion sensor to detect motion of the controller and generate corresponding signal commands to the game. The controller also provides a number of ergonomically placed buttons allowing further user input corresponding to one or more of the buttons available on the game housing.

### PRIOR APPLICATION

This application claims the benefit of U.S. Provisional application Ser. No. 60/795,316 filed Apr. 27, 2006.

### FIELD OF THE INVENTION

This invention relates to portable electronic devices such as hand-held computers, personal digital assistants (“PDAs”), mobile or cordless telephones, calculators, remote controls, and more particularly to hand-held computer games such as the PLAYSTATION PORTABLE brand or PSP brand portable electronic gaming device available from Sony Computer Entertainment, Inc. of Tokyo, Japan, hereinafter the “PSP game” or “PSP device”.

### BACKGROUND

Hand-held computer game devices such as those described in Karten et al. (U.S. Pat. No. 7,153,212) incorporated herein by this reference, and the PSP device often provide games such as the so called “first person shooter”-type games where the player views on a display a computer generated, three dimensionally rendered environment such as a room showing targets which the player must shoot to score points. The player can change his point of view and aim and fire a weapon such as a gun through manipulation of buttons located on the housing of the PSP device.

The realism of the game is important to the enjoyment of it. Since most, if not all, gun-type weapons are not held and fired in the same manner as a PSP device, the realism of the game is diminished.

Further, the flexibility of button placement on held-held electronic devices is typically limited. Since individual users may desire different types of inputs, and different button layouts, it is desirable to enhance the flexibility of hand-held electronics to allow for more alternatives in user input.

The invention came about in order to address the above identified problems.

### SUMMARY

It is an object of the invention to provide greater flexibility to input signals into hand-held electronic devices.

These and other objects are achieved by a detachable user input controller having the ability to input control signals into a hand-held electronic device.

In one embodiment there is provided a PSP device Gun Controller used for controlling shooting game operating on a PSP device. The gun controller contains a 3d motion sensor. This sensor is used to control the action within the game. The sensor will provide full range of motion, including up, down, left and right and potentially unlimited pitch, roll and yaw movement depending on the game program. The controller provides means for physically mounting the PSP device to the gun controller in the form of a mount including a locking mounting bracket. A connector on the gun controller plugs into the top of the PSP device. The connector contains the IR blaster as well as the USB connection. A mount slide allows the user to move the PSP device closer or further away from the point of view of an operator. A button located near the mount allows the user to release the PSP device from the gun controller. The PSP device is controlled through the IR blaster via the mount. The PSP device can also be controlled via standalone means while plugged into the gun controller. A battery can be provided in the gun controller, which will supply energy to the electronics on the gun controller and a rumble effect actuator including rumble effect motors. Alternatively, the gun controller can derive its power from the PSP device via the USB port. The gun controller is provided with a trigger mechanism. When the user pulls the trigger on the gun, the “X” button command will be sent to the PSP device via IR. The gun controller also will provide a force feedback function, which will be felt by the player when the trigger is pulled. The type and amount of force feedback can be adjusted by the gun controller circuitry.

A thumb button is placed on the left side of the gun and can send the “Left Shoulder” button command to the PSP device via IR. On the right side of the gun there are 4 buttons. The buttons all have the same look and feel (as seen in the Figures). Each button will issue a different command. All buttons will send a specific command to the PSP device via IR. The following is an embodiment of the button configuration:

Button 1—Triangle

Button 2—Square

Button 3—Circle

Button 4—Left shoulder

### BRIEF DESCRIPTION OF THE DRAWING

FIG. 1 is a right side elevation view of the novel showing a PSP device gun controller according to the invention showing the PSP device mounted onto a top surface;

FIG. 2 illustrates the manner in which the gun controller is held and operated;

FIG. 3 is a rear elevation view of the PSP device and gun controller of FIG. 1;

FIG. 4 is a right side elevation view of the PSP device and gun controller of FIG. 1;

FIG. 5 is a front elevation view of the PSP device and gun controller of FIG. 1;

FIG. 6 is a right side elevation view of the PSP device and gun controller of FIG. 1 with the different components identified thereon;

FIG. 7 is an enlarged schematic view of the PSP device gun controller with the PSP device mounted thereon;

FIG. 8 is a top plan view of the PSP device gun controller illustrated in FIG. 7 showing exemplary width in millimeters;

FIG. 9 is an enlarged right side schematic view of the PSP device gun controller showing exemplary dimensions in millimeters;

FIGS. 10-11 are enlarged schematic top, back, right side perspective views of the PSP device gun controller with the PSP device mounted thereon;

FIG. 12 is a block diagram showing how an exemplary Sony PSP device console is electronically connected to the PSP device gun controller; and

FIGS. 13-16 illustrate the electronic circuitry components of the PSP device gun controller according to the invention.

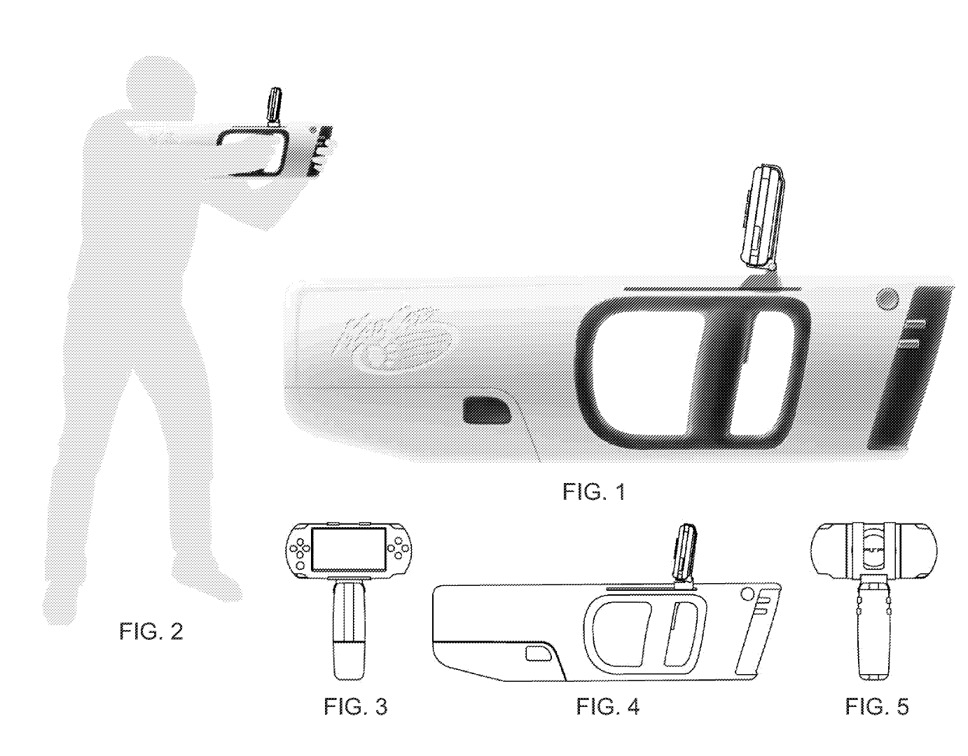

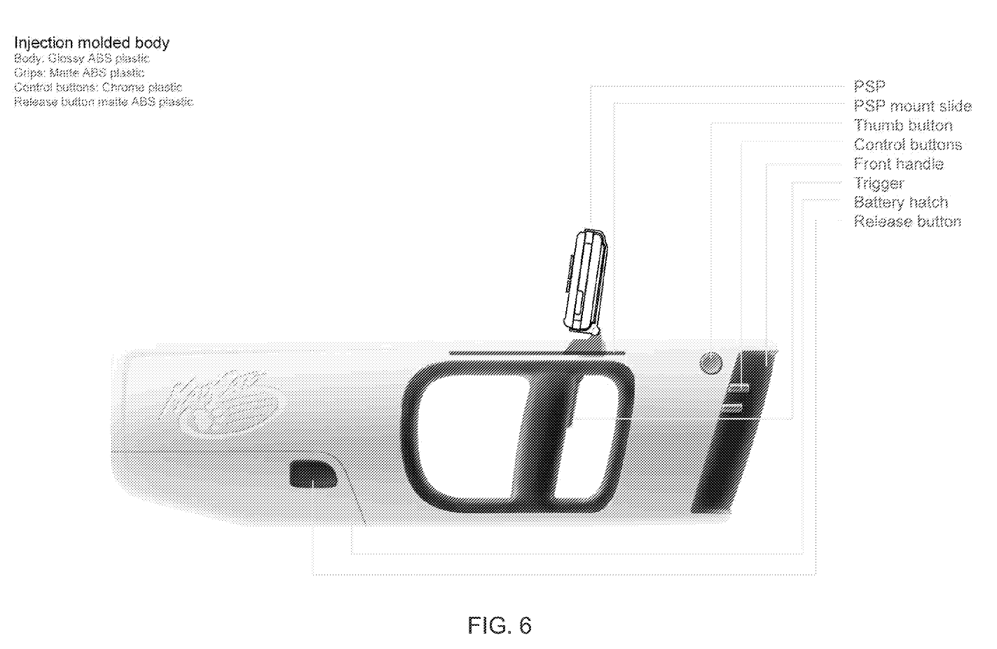

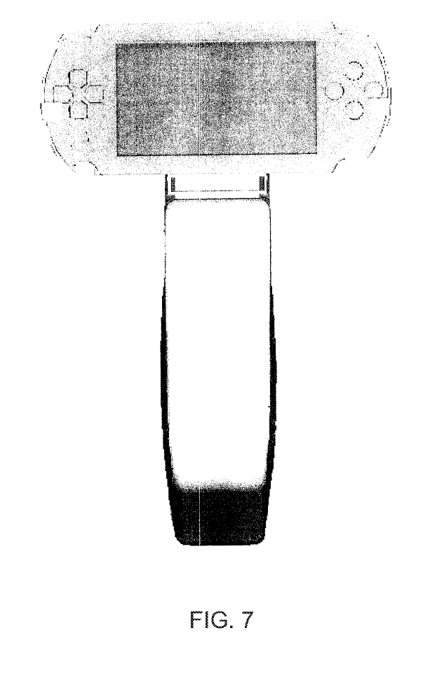

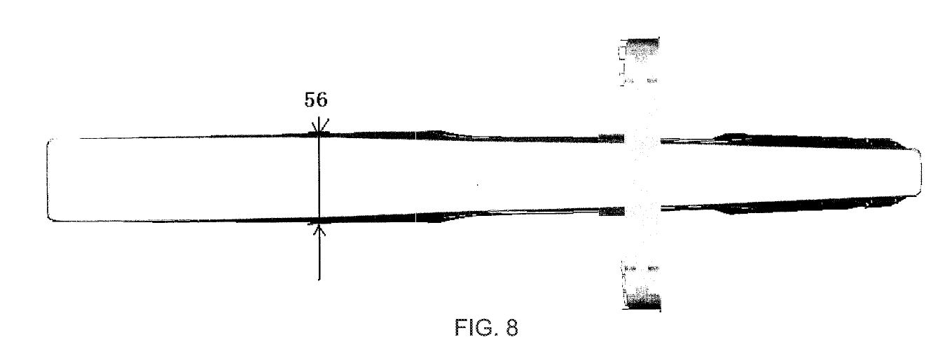

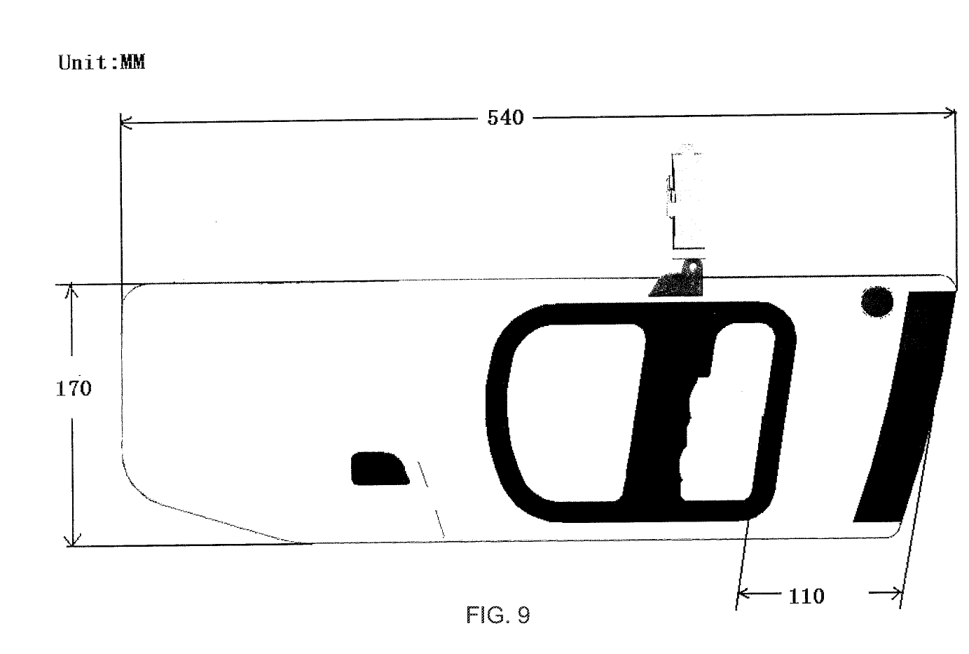

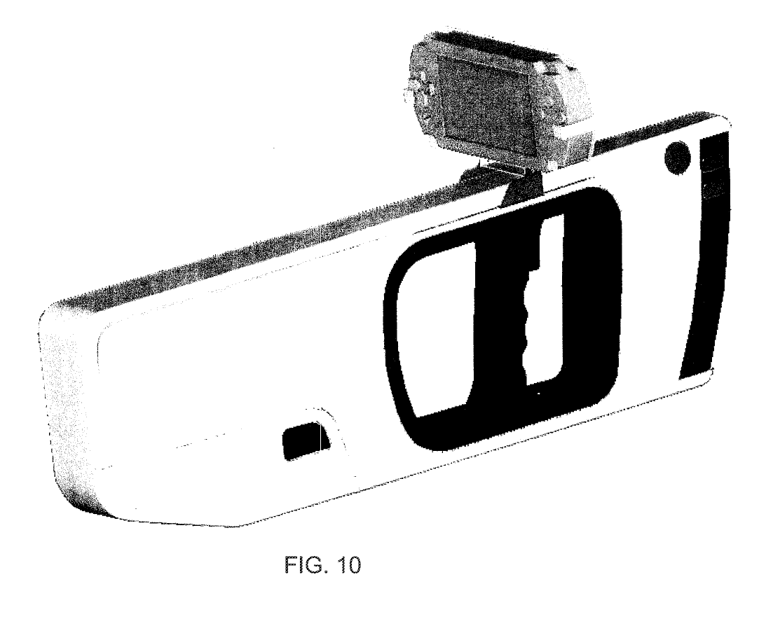

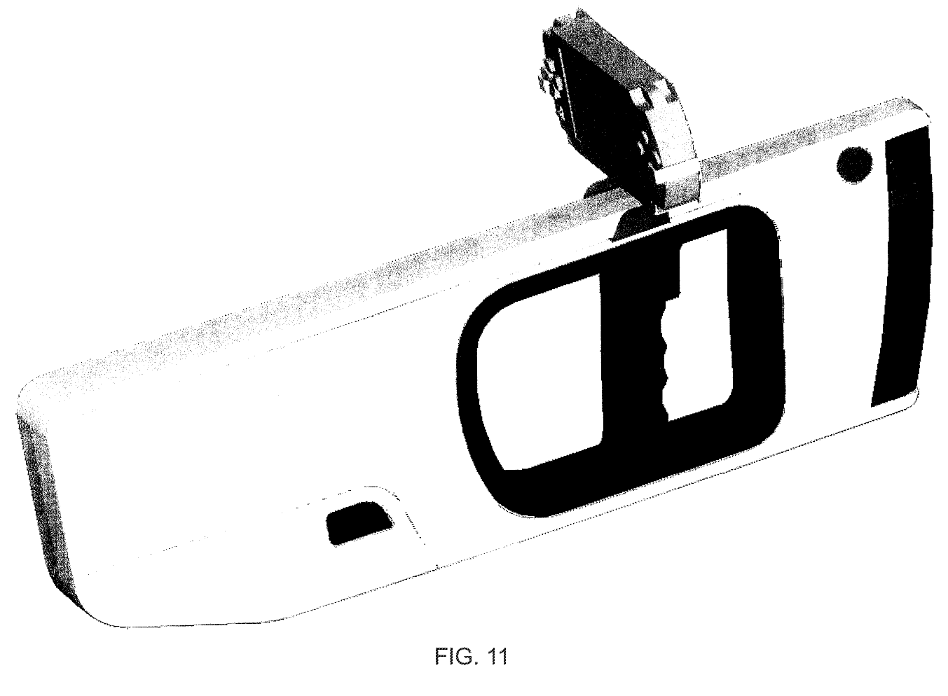

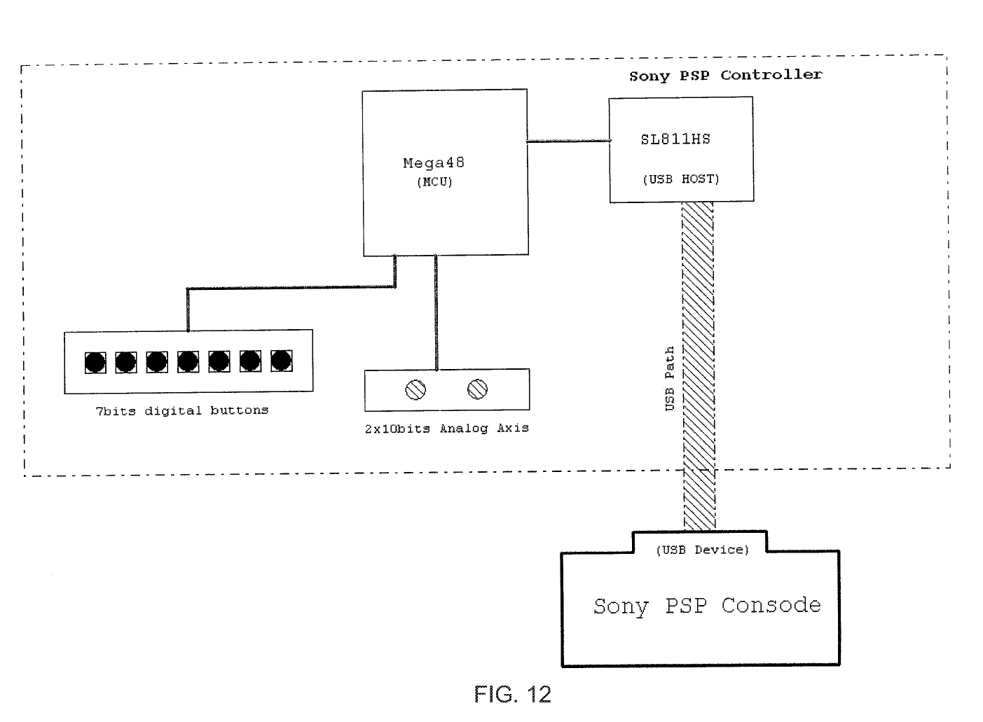

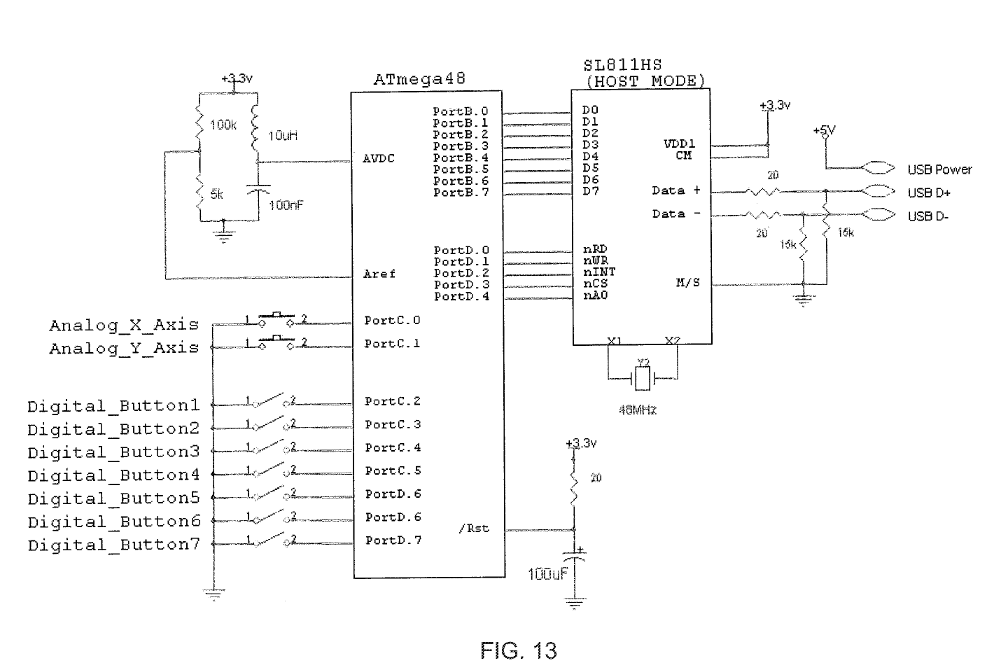

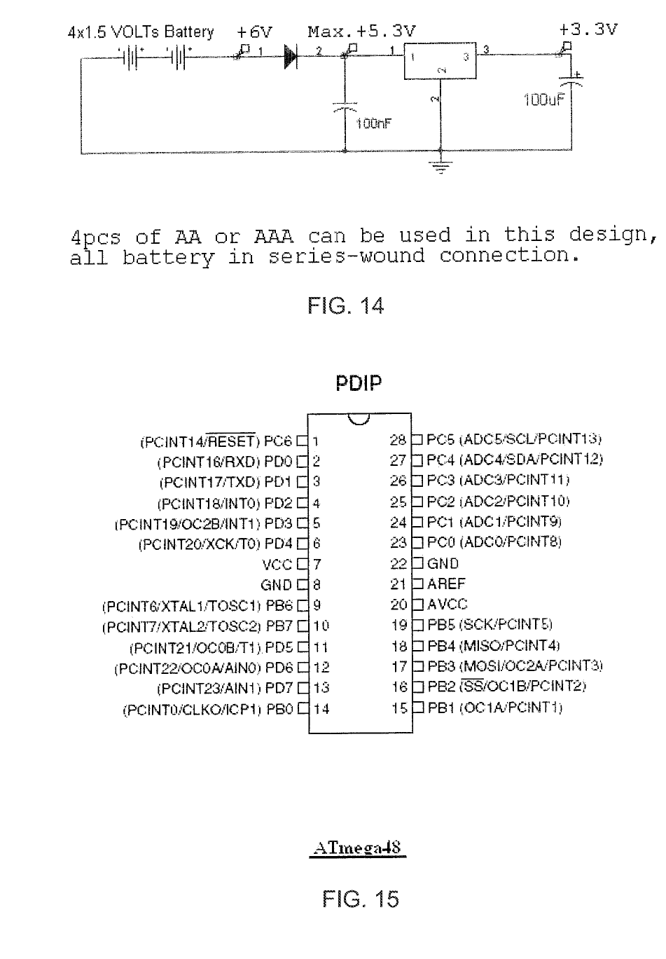

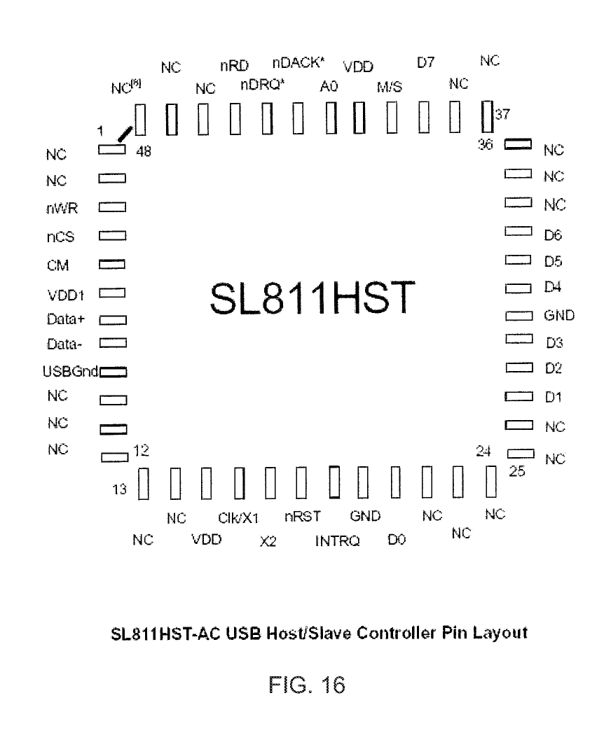

### DESCRIPTION OF THE PREFERRED EMBODIMENT(S)

The preferred PSP device gun controller will utilize the following Power Specification:

Used 4 pcs size AAA with 1.5 Volts battery, or 4 pcs size AA with 1.5 Volts battery.

The power consumption of the controller is typically between 20 mA˜40 mA.

5 Volts power will be supplied to PSP device USB power source.

[image]

4 pcs of AA or AAA batteries can be used in this design, wherein the all batteries are connected in series.

The resolution of the analog X-Axis, Y-axis and digital buttons:

[image]

Each axes has 1024 levels(value 0x000˜0x2FF), that can vary by human activity. Digital buttons define ‘1’ to be ‘OFF’ state, and ‘0’ to be the ‘On’ state.

[image]

Above there is shown the flowchart of the gun controller and how it communicates with the PSP device or machine.

The steps in operating the gun controller with the PSP device machine include:

1) Plug in the PSP device to the gun controller from USB path.

2) Power on the gun controller with AA or AAA battery.

3) Power on PSP device.

4) In the PSP device games, enable the USB communication (act as device).

5) Gun controller detects the device plug in from USB port.

6) The gun controller asks for device descriptors by full-speed mode(usb1.1) which:
Assigns the device address
Gets Device descriptor
Gets Strings descriptor
Gets Configuration descriptor
Gets Interface, endpoints descriptor

7) Gun controller scans the human activity by 7 digital buttons, and 2x10 bits analog axis.

8) Gun controller sends the human activity to PSP device machine through endpoint2 of the interface0(Polling method with maximum 20 millisecond)

[image]

USB Packet Format is:

No. of bytes: 0x06, which means the number of 6 byte inside a packet.

Digital byte0:
bit0=button1
bit1=button2
bit2=button3
bit3=button4
bit4˜bit7 be reserved bit.

Digital byte1:
bit0=button5
bit1=button6
bit2=button7
bit3˜bit7 be reserved bit.

X-axis and Y-axis are the 10 bits resolution device, which are:

X-axis byte0: 0x00˜0xFF

X-axis byte1: 0x00˜0x03(bit2˜bit7 be reserved)

Y-axis byte0: 0x00˜0xFF

Y-axis byte1: 0x00˜0x03(bit2˜bit7 be reserved)

While the preferred embodiment of the invention has been described, modifications can be made and other embodiments may be devised without departing from the spirit of the invention and the scope of the appended claims.

What is claimed is:

1. The combination of a hand-held electronic device and an electronic controller, wherein said controller mounts to said device and wherein user manipulation of said controller generates electronic signal commands for controlling a program running on said device.

2. The combination of claim 1, wherein said controller further comprises a three dimensional motion detector and wherein an output of said detector is used to generate orientation commands to the device running a game using orientation commands.

3. The combination of claim 2, wherein said controller is detachably secured to said device by a locking mounting bracket.

4. The combination of claim 2, wherein said controller is physically mounted to said device so that both of said controller and device move in unison.

5. The combination of claim 4, wherein said mounting allows for unlimited pitch, roll and yaw movement.

6. The combination of claim 1, which further comprises means for powering said controller.

7. The combination of claim 6, wherein said means for powering comprise at least one battery mounted within said controller.

8. The combination of claim 6, wherein said means for power comprise a power line connected to said device across said mount.

9. A gaming controller configured as a gun.

10. A gaming controller upon which a PSP brand device (PLAYSTATION PORTABLE brand) entertainment system is detachably mounted.

11. The concept of taking any viewing device and attaching it to a peripheral and using that as the method of viewing and interacting with the video game.

12. The concept of taking a portable entertainment system for playing games and mounting it on a peripheral and the entertainment system communicates with the peripheral and the software in the game.

13. The concept of putting the gaming console on the peripheral so that a person can walk around from room to room and play a video game on the game console.

14. The concept of mounting a screen on a peripheral (such as a controller) and being able to walk around playing a video game on a video game console that is located in another room or part of a building or house.

15. The concept of using an outside peripheral to control a handheld console (i.e. the buttons that are controlling are not physically on the handheld).
